(19) United States
(12) Patent Application Publication
(10) Pub. No.: US 2008/0191882 A1
(43) Pub. Date: Aug. 14, 2008

(54) RADIO FREQUENCY IDENTIFICATION SYSTEM AND METHOD

(75) Inventors: Bo ZHOU, Beijing (CN); Xiaowei LIU, Beijing (CN); Min-Yu HSUEH, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) Co., Ltd., Beijing (CN)

(21) Appl. No.: 12/030,348

(22) Filed: Feb. 13, 2008

(30) Foreign Application Priority Data
Feb. 14, 2007 (CN) 200710079826.1

(51) Int. Cl. G08B 13/14

(52) U.S. Cl. 340/572.4; 340/10.1

(57) ABSTRACT

The invention provides a radio frequency identification system and method. The radio frequency identification system according to the invention comprises: a multi-core tag including a plurality of radio frequency identification tags, each radio frequency identification tag having an identification code and at least one set of verifiable data stored therein; and a radio frequency identification reader which sends a reading request to more than one radio frequency identification tag in the multi-core tag, requesting to read a first portion of one of the at least one set of verifiable data stored in the radio frequency identification tag, and authenticates the multi-core tag based on the data read from the multi-core tag, wherein each radio frequency identification tag in the multi-core tag further comprises control means, which, when the radio frequency identification tag receives the reading request from the radio frequency identification reader, in the event that all the data of the requested set of verifiable data is readable, performs a first operation so that from then on at least one data of the requested set of verifiable data cannot be read.

### FIELD OF THE INVENTION

The present invention generally relates to computer systems, more particularly, to a radio frequency identification (RFID) system and a radio frequency identification method.

### BACKGROUND OF THE INVENTION

Counterfeits are extremely severe trouble to product manufacturers. Today, counterfeits can be seen in many industries, e.g. wine, cigarette, drug, cosmetics, CD, DVD, software, sports appliance, children's article, jewelry, etc. For decades, the industries are combating with the forgers. However, along with the continuous march of anti-counterfeit effort, counterfeits are getting incredibly prevalent in most countries, no matter western or eastern.

Counterfeits bring to innocent manufacturers not only huge loss in terms of profit, but also disaster in terms of credit. An ordinary consumer, who unfortunately buys counterfeit and is dissatisfied with the poor quality of the counterfeit, in many cases cannot distinguish the counterfeit from genuine product, therefore will negatively however falsely assess the product quality of the genuine manufacturer. The final sad story is: the forger makes money while the innocent manufacturer gets punished.

The product manufacturers are always thirsting for product authentication solutions that can help consumers to distinguish genuine products from fake ones. If the solution makes it handy for the consumer to authenticate product, the counterfeits will be easily driven out of the market.

Anti-counterfeit is a very hot topic in patent applications and many solutions have already been seen in the market. Before the wide adoption of computer communication network, the anti-counterfeit solutions are in general based on physical means, e.g. special printing ink, paper, texture and laser label. Such physical means are alleged by the solution providers as strong against counterfeit. But, past decades of history clearly disagree with those providers' allegation. The bank note is a very good example. The most advanced physical means can always be found in the bank note. However, fake bank notes never disappear. Apparently, ordinary product manufacturers cannot stand the high cost that applies to bank note anti-counterfeit. Therefore, anti-counterfeit solutions adopted by ordinary product manufacturers are very vulnerable.

In past 20 years, computer communication networks successfully break through to the consumer market. Global Internet access fee and fix/mobile telecommunication fee get so low that they are affordable to a large portion of the people living on the planet. Consequently, it's not surprising to see more and more anti-counterfeit solutions that try to transmit product authentication information conveyed by the product to a backend server and let the server decide whether the product is real or fake. For example Chinese patent applications 99126659 and 02111542 fall in this class of technique.

RFID tag is another rising star in fighting against counterfeits. The term RFID covers a family of radio and processor technologies that have widely varying amounts of computational power, read range, and cost. Supply chain tags have been famous since WalMart and U.S. Department of Defense started large scale trials. The industry body EPCglobal (www.epcglobaline.org) has defined Class 0 and Class 1 RFID tags that have extremely limited computation, storage, and communication capabilities, with no support for cryptography and minimal additional features.

Three components are fundamental to any RFID system: the RFID tag, the RFID reader and the data processing subsystem. The RFID tag is located on the object to be identified and is the data carrier in the RFID system. The RFID reader is able to read data from and/or write data to the RFID tag. The data processing subsystem utilizes the data obtained by the RFID reader in some useful manner.

Typical RFID tags include a microchip that stores data and a coupling element, such as a coiled antenna, for communicating via radio frequency communication. RFID tags may be either active or passive. Active RFID tags have an on-tag power supply (such as a battery) and actively send an RF signal for communication, while passive RFID tags obtain all of their power from the interrogation signal of the RFID reader and either reflect or load modulate the RFID reader's signal for communication. Most RFID tags, both passive and active, communicate only when they are interrogated by an RFID reader.

Typical RFID readers include a radio frequency module, a control unit, and a coupling element to interrogate RFID tags via radio frequency communication. In addition, many RFID readers are fitted with an interface that enables them to communicate their received data to a data processing subsystem, e.g., a database running on a personal computer. The use of radio frequencies for communication with RFID tags allows RFID readers to read passive RFID tags at small to medium distances and active RFID tags at small to large distances even when the tags are located in a hostile environment and are obscured from view.

Anti-counterfeit solutions that utilize RFID tag could be simply classified as online ones and offline ones. For the online anti-counterfeit solutions, computer communication networks are used as well. Such solutions may or may not entail security means. For example, Chinese patent applications 200410082611.1 and 200410024790.3 fall in this class of technique, while the former does not touch security means and the latter mandates security means. On the other hand, for the offline solutions, computer communication networks are not utilized, i.e. only the RFID tag and reader are utilized to authenticate products. In this case, security means are inevitably necessary. For example, Chinese patent applications 03111875.5 and 200410078160.4 fall in this class of techniques. PCT patent application WO 2005/024697 A2 is also of this class.

Existing anti-counterfeit solutions have problems in terms of cost, efficiency, usability and security.

Above all, any anti-counterfeit solution that mandates communication network support will encounter big cost on the backend server so as to handle mass product authentication queries from the consumers. Further, the communication expense will be imposed on either the consumer or the product manufacturer. If it's imposed on the consumer, such solutions will be abandoned by most of the consumers for obvious economic reasons. On the other hand, if it's imposed on the product manufacture, the mass product authentication queries from the consumers may eat up the profit of the product manufacture. That's not all. In most cases, the communication between the consumer and the backend server for product authentication takes significant time. Consumers may also turn away from such kind of solutions for time reasons.

Existing offline tag-based anti-counterfeit solutions, i.e. solutions that do not need communication network support, encounter cost as well as security troubles. Although security means have been incorporated in such kind of solutions, most of them actually are not working. Such kind of solutions generally relies on the assumption that the tag contains certain secret information and is clone-resistant, i.e. given a genuine tag containing secret information it's hard to fabricate another tag that contains the same information. If such assumption is true, those solutions are doable because security means guarantee that the secret information stored in the tag is not forgeable therefore the secret information and the tag is securely bound. Unfortunately, this assumption is totally incorrect for existing solutions. Existing solutions use all the secret information stored in the tag for product authentication. As we know, for an offline solution, it's the reader that authenticates the tag and make judgment on the authenticity of the product being attached the tag. Since all the secret information stored in the tag is used in authentication, if any one of the reader is occupied by the forger, the forger may figure out the secret information stored in the reader, exactly copy the secret information to a fake tag and in the sequel break the security of the solution. Fabricating a secure reader against conquering by the forger is possible. However, such a reader is too expensive. Similarly, it is easy to find that the radio communication between the reader and the tag is hard to be secured by security means. If the radio communication between the reader and the tag is secure, not only an expensive reader but also expensive tags are necessary for them to authenticate each other. As the consequence, the data contained in the tag could be intercepted through simply eavesdropping of the open radio communication between the reader and the tag. We conclude that an RFID tag is prone to be cloned unless an expensive tag that can authenticate the reader as well as authenticated by the reader is utilized and the radio channel between the reader and the tag is encrypted.

Here we emphasize that the inexpensive tag are at least characterized by “passive tag that has very limited computation power”. Fundamental security requirements such as pseudorandom number generation, hashing and ciphering are not available to the tag. For such an inexpensive tag, anti-clone of data is painful to all product authentication solutions. Cloned tags are fatal to especially the offline ones. The reader without network support cannot distinguish a genuine tag from a cloned one, which implies that the fake tag will definitely pass the product authentication by any genuine reader. Consequently, mass counterfeits are inevitable because a counterfeit being attached a cloned tag will be authenticated by the reader as authentic.

Some solutions addressed to the problem of data clone of offline RFID tags have been proposed. For example, Japanese Patent Publication 2005-130059 discloses a solution, which, by writing a plurality of encrypted data into a storage area of an IC chip attached to a product and reading the encrypted data in the chip for a number of times, increases the difficulty of interpreting encrypted data and thus increases the difficulty of data clone to some extent. However, data clone is still possible. The forger can obtain all the encrypted data stored in a genuine chip by reading the chip for enough number of times, and clone the data into the fake chip. A chip thus forged can definitely pass the product authentication by any genuine reader.

Therefore, there is a demand for an RFID system for offline product authentication, which can prevent cloning of data stored in an RFID tag, and has the advantages such as cheapness and efficiency.

### SUMMARY OF THE INVENTION

In order to solve the above problems, that is, to prevent cloning of data stored in a radio frequency identification tag by means of an inexpensive and efficient solution, a radio frequency identification system, a multi-core tag and a radio frequency identification method are provided.

According to a first aspect of the invention, there is provided a radio frequency identification system, comprising: a multi-core tag including a plurality of radio frequency identification tags, each radio frequency identification tag having an identification code and at least one set of verifiable data stored therein; and a radio frequency identification reader which sends a reading request to more than one radio frequency identification tag in the multi-core tag, requesting to read a first portion of one of the at least one set of verifiable data stored in the radio frequency identification tag, and authenticates the multi-core tag based on the data read from the multi-core tag, wherein each radio frequency identification tag in the multi-core tag further comprises control means, which, when the radio frequency identification tag receives the reading request from the radio frequency identification reader, in the event that all the data of the requested set of verifiable data is readable, performs a first operation so that from then on at least one data of the requested set of verifiable data cannot be read.

According to a second aspect of the invention, there is provided a multi-core tag comprising a plurality of radio frequency identification tags, each radio frequency identification tag having an identification code and at least one set of verifiable data stored therein, wherein each radio frequency identification tag in the multi-core tag comprises control means, which, when the radio frequency identification tag receives a reading request for reading a first portion of one of the at least one set of verifiable data stored in the radio frequency identification tag, in the event that all the data of the requested set of verifiable data is readable, performs a first operation so that from then on at least one data of the requested set of verifiable data cannot be read.

According to a third aspect of the invention, there is provided a radio frequency identification method, comprising: storing an identification code and at least one set of verifiable data in each of a plurality of radio frequency identification tags included in a multi-core tag; and sending a reading request from a radio frequency identification reader to more than one radio frequency identification tag in the multi-core tag to request to read a first portion of one of the at least one set of verifiable data stored in the radio frequency identification tag, and authenticating the multi-core tag based on the data read from the multi-core tag, wherein each radio frequency identification tag in the multi-core tag, when receiving the reading request from the radio frequency identification reader, in the event that all the data of the requested set of verifiable data is readable, performs a first operation so that from then on at least one data of the requested set of verifiable data cannot be read.

It can be seen from the above that according to the embodiments of the present invention, a locking function is introduced into the RFID tag. And furthermore, multiple RFID tags are aggregated into a multi-core tag. As such, the probability that a fake product will be detected can be significantly increased through a plurality of digital signatures (i.e. verifiable data) stored in each RFID tag and the locking function carried out by each RFID tag as well as the authentication performed as a whole on all the RFID tags in the multi-core tag. Thus cloning of data in an inexpensive radio frequency identification tag can be effectively prevented and mass counterfeits can be thwarted.

In addition, in each RFID tag, multiple digital signatures are divided into sets and stored in the RFID tag. By introducing signature sets, it's guaranteed that a genuine tag could be verified as authentic for multiple times.

### BRIEF DESCRIPTION OF THE DRAWINGS

FIG. 1 shows an RFID system 100 comprising a multi-core tag 101 and an RFID reader 102 according to a first embodiment of the invention;

FIG. 2 is a schematic diagram showing the internal structure of an RFID tag 101-1 in the multi-core tag 101 according the first embodiment of the invention;

FIG. 3 is a schematic diagram showing the internal structure of the RFID reader 102 according the first embodiment of the invention;

FIG. 4 is a flow chart showing the flow of operations of the RFID tag 101-1 in the multi-core tag 101 shown in FIG. 1 upon receiving a reading request from the RFID reader 102;

FIG. 5 is a flow chart showing the flow of operations of the RFID reader 102 for sending the reading request to the multi-core tag 101 and authenticating the multi-core tag 101 based on the read digital signatures;

FIG. 6 shows the flow of steps 502 and 503 in FIG. 5 in further detail; and

FIG. 7 shows the flow of step 504 in FIG. 5 in further detail.

### DETAILED DESCRIPTION OF THE PREFERRED EMBODIMENTS

The embodiments of the invention will be explained below.

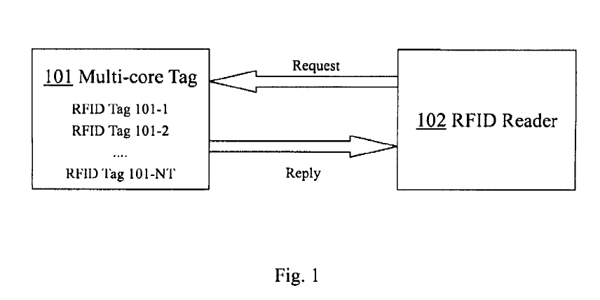

FIG. 1 is a simplified block diagram showing an RFID system 100 according to a first embodiment of the invention. The RFID system 100 comprises a multi-core tag 101 and an RFID reader 102. As shown, the multi-core tag comprises NT RFID tags 101-1, 101-2, . . . 101-NT with identical internal structure. Each RFID tag communicates with the RFID reader 102 through radio frequency communication. Each RFID tag is a passive tag, which obtains all of its power from a reading request signal from the RFID reader 102 and either reflect or load modulate the RFID reader 102's signal in order to make response. Each RFID tag has a very small size, and thus the multi-core tag 101 constituted by them has a very small size, and can be attached to any product to be authenticated. The RFID reader 102 can sends data, such as the reading request, to the multi-core tag 101, and receive any reply data from the multi-core tag 101.

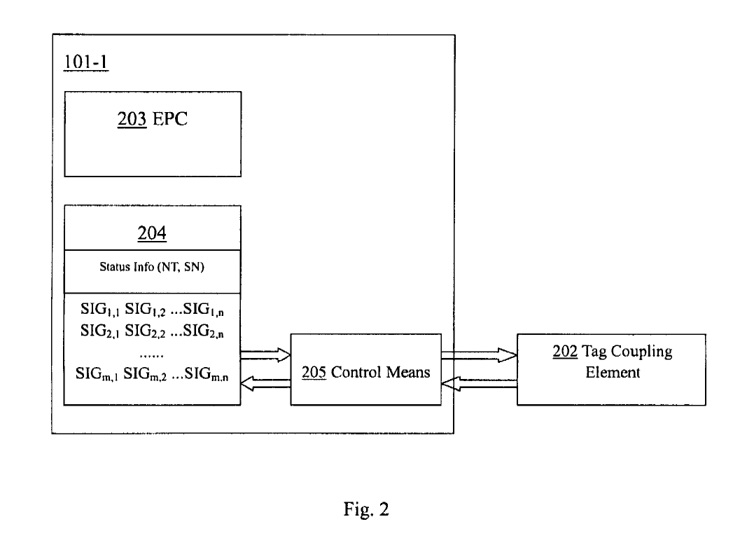

Taking RFID tag 101-1 as an example, the internal structure of the RFID tags included in the multi-core tag 101 will be explained with reference to FIG. 2. The internal structure of other RFID tags in the multi-core tag 101 is similar or identical to that of RFID tag 101-1.

FIG. 2 is a schematic diagram showing the internal structure of the RFID tag 101-1 in the multi-core tag 101 shown in FIG. 1.

The RFID tag 101-1 comprises a microchip 201 and a tag coupling element 202. The microchip 201 includes an identification code storage area 203, a supplementary storage area 204 and control means 205. An attribute identification code uniquely identifying the RFID tag 101-1, such an EPC code (Electronic Product Code), is stored in the identification code storage area.

The EPC code is defined by EPCglobal. A portion of the EPC code will uniquely identify the manufacturer of the product being attached the RFID tag 101-1. EPC is the only information stored in the RFID tag, and has been supported by UCC and International EAN, two major surveillance organizations for international standards. The object of EPC is to provide an unique identity for an object of the physical world. It identifies and accesses a single object through computer networks in the similar manner as identifying, organizing and communicating through IP addresses in an internet. The structure of an EPC code will be explained briefly below. EPC is a set of digits, consisting of a head mark and three portions of data. The head mark indicates the version number of the EPC, and has taken into consideration the different lengths and types of future tags. The second portion indicates the administrator of the EPC, corresponding to the manufacturer of the product. The third portion represents the class of the product, indicating the exact categorization of the product. The forth portion is the sequence number of a product item. For example, an EPC code 01.115A1D7.28A1E6.421CBA30A, wherein 01 represents the version of the EPC (8 bits), 115A1D7 represents the identification code of the manufacturer of the product and includes 28 bits in total (capable of representing more than 268 millions of manufacturers), 28A1E6 represents the identification code of the product and includes 24 bits in total (each manufacturer can have more than 16 millions of classes of products represented), and 421CBA30A represents the sequence number of the product item and includes 36 bits in total (each class of product can have more than 68 billions of items represented).

Stored in the supplementary storage area 204 are status information, verifiable data as well as other supplementary information, e.g. date of manufacture.

The status information includes the total number NT of RFID tags in the multi-core tag 101 and the sequence number SN of this RFID tag in the multi-core tag 101. The total number NT and sequence number SN are stored in the supplementary storage area 204 when the multi-core tag 101 is manufactured. When manufacturing a multi-core tag, it will be guaranteed that the total number of tags indicated by the status information of each RFID tag therein is the same, i.e., equal to the total number of RFID tags in that multi-core tag; and that for each RFID tag in the multi-core tag, the SN is unique, acting as the unique identification of the RFID tag in the multi-core tag.

A number of ways exist for generating the verifiable data in the supplementary storage area 204. The examples thereof will be described below.

In a preferred embodiment of the present invention, the verifiable data can be digital signatures. As shown in FIG. 2, The supplementary storage area 204 of RFID tag 101-1 stores m sets of digital signatures, each comprising n digital signatures, forming a matrix of digital signatures {SIG_{i,j}}, where 1≦i≦m, 1≦j≦n, and m and n are positive integers.

Assume that each manufacturer has at least one public-key, and the digital signatures are digital signatures on the content of EPC. These signatures are verified by the public-keys of the manufacturer. For example, assume n=2, that is, each set of digital signatures contains 2 digital signatures SIG₁ and SIG₂, and the manufacturer has two RSA public-keys, PK₁ and PK₂, each of 1024 bits. Then SIG₁ and SIG₂ could be digital signatures on EPC and date of manufacture that can be verified by PK₁ and PK₂. Each signature consumes 1024 bits. Preferably, the signatures are computed using ECDSA (ANSI X9.62) akin mechanisms so that one manufacture requires only one public-key. According to this mechanism, each signature has two portions S and C, each of e.g. 160 bits if using 160 bits elliptic curve and SHA-1. In other words, one digital signature consumes only 320 bits. However, the security strength is comparable to the security of 1024 bit RSA digital signature scheme. Such various choices and considerations on digital signature schemes are well known to those skilled in the art.

In addition to generating as digital signatures, the way of generating the verifiable data can alternately be the MAC (Message Authentication Code) method well known in the art. For example, given a secure hashing function and a message M (including an EPC code E and any possible additional information), n pieces of verifiable data in each set of verifiable data can be computed as MACᵢ=hash (M, key, i), i=1, 2, . . . n. MAC₁˜MAC_{N} are stored in the tag as a set of verifiable data. When the reader reads any verifiable data in a set of verifiable data, for example, MACⱼ, whether MACⱼ equals to hash (M, key, j) can be verified based on the sequence number j of the MAC value, the associated message M and the secret key “key” in the reader's own memory. If the answer is “YES”, then this MAC value is genuine. Otherwise, this MAC value is faked. MAC can be generated by other methods, for example, HMAC, and there are a lot of choices for the secure hashing function. All these are well known to those skilled in the art.

As another example, the way of generating the verifiable data can alternately be the symmetric encryption method as well known in the art. Specifically, given a symmetric encryption function SEC, a decryption function SDE, and a message M (including an EPC code E and any possible additional information), n pieces of verifiable data in a set of verifiable data can be computed as Dᵢ=SEC (M, key, i), i=1, 2, . . . n. D₁˜Dₙ are stored in the tag as a set of verifiable data. When the reader reads any verifiable data, for example, Dⱼ, whether SDE (Dⱼ, key) can decrypt M and j can be verified based on the sequence number j of the data, the associated message M and the secret key “key” in the reader's own memory. If the answer is “YES”, then this piece of verifiable data is genuine. Otherwise, it's fake. There are a lot of choices for the symmetric encryption method, for example, 3DES and AES, all of which are well known to those skilled in the art.

The above schemes for generating the verifiable data without using digital signatures can be extended as follows: a number of secret keys belonging to different manufactures are stored in the reader, and the verifiable data stored in the tag which declares in its EPC that it belongs to a manufacture can be verified by the secret key of the manufacture stored in the reader.

The main problem with the above verifiable data generating schemes without the use of digital signatures is that the extendibility of these schemes is very poor if each manufacture has different secret keys. If a reader stores secret keys of thousands of manufactures, then it will become a huge security issue. Meanwhile, it is difficult to add secret keys to the reader in a secure manner. On the other hand, the scheme of sharing one secret key among all the manufactures is also very poor in the extendibility. This is because that in this case the secret key can only be used by a commonly recognized trustworthy third party, which makes it necessary for the third party to generate verifiable data for all the products of all the manufacturers and which is also very difficult.

Therefore, using digital signatures as verifiable data is preferred in the present invention.

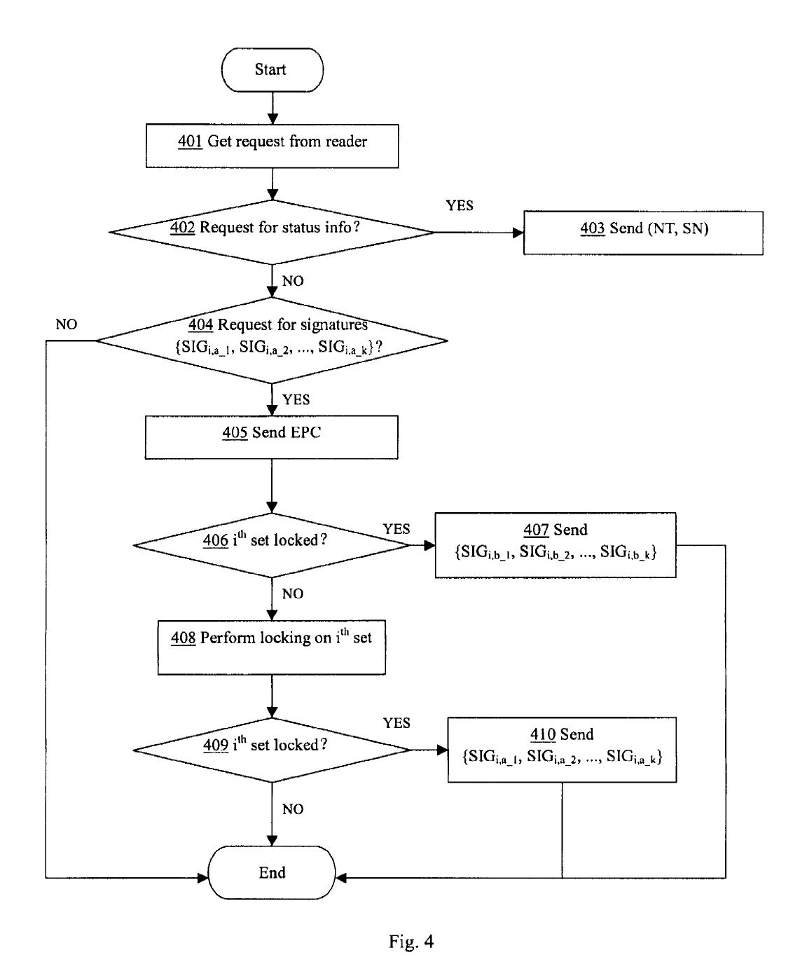

The control means 205 is used to perform a locking operation, which causes a portion of digital signatures of a set of digital signatures stored in the supplementary storage area 204 of the RFID tag 101-1 can not be read from then on depending on the condition when the RFID tag receives a reading request from the RFID reader. The operations of the control means 205 will be further described below in conjunction with FIG. 4.

The tag coupling element 202 can be a coiled antenna for communicating with the RFID reader 102 through radio frequency communication.

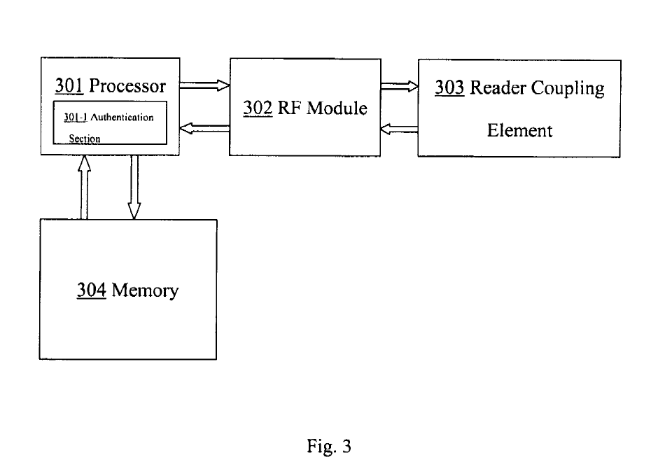

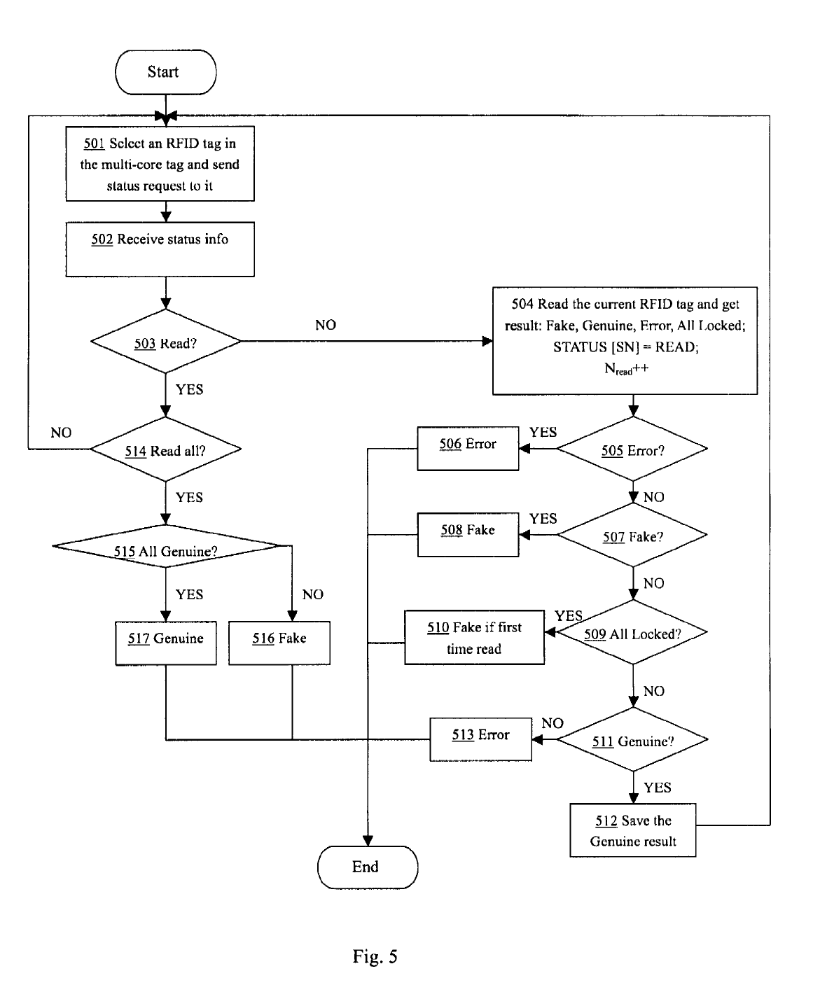

FIG. 3 is a schematic block diagram showing the internal structure of the RFID reader 102 shown in FIG. 1. The RFID reader 102 comprises a processor 301, a radio frequency module 302, a reader coupling element 303 and a memory 304. The processor 301 is used for controlling the RFID reader 102 to send a reading request to the multi-core tag 101 via the coupling element 303. The processor 301 further comprises an authentication section 301-1 for analyzing the reply data received from the multi-core tag 101 to authenticate the mutli-core tag 101 so as to authenticate the product being attached the multi-core tag 101. The operations of the processor 301 will be further described below in conjunction with FIGS. 5˜7. The radio frequency module 302 is used to generate radio frequency signals under the control of the processor 301. The reader coupling element 303 is used to communicate with the multi-core tag 101 by transmitting/receiving radio frequency signals. The memory 304 is for storing the public keys of the manufactures. In case of using RSA algorithm to compute the digital signatures, if there are m sets of digital signatures stored in the supplementary storage area 204 of each RFID tag in multi-core tag 101 and each set of digital signatures comprises n digital signatures, then there are n public keys {PK₁, PK₂, . . . , PKₙ} stored in the memory 304. However, in case of using ECDSA algorithm to compute the digital signatures, no matter how many digital signatures are stored in the supplementary storage area 204, for one manufacture, only one public key is required to be stored in the memory 304 for verifying the digital signatures of that manufacture.

The flow of operations of each RFID tag in the multi-core tag upon receiving a reading request from the RFID reader will be described with reference to FIG. 4.

FIG. 4 is a flow chart showing the operations of RFID tag 101-1 in the multi-core tag 101 shown in FIG. 1 upon receiving a reading request from the RFID reader 102. The operations of other RFID tags in the multi-core tag are similar to those of RFID tag 101-1. In step 401, the RFID tag 101-1 receives a request from the RFID reader 102. In step 402, RFID tag 101-1 determines whether the received request is a request for status information. If the answer is “YES”, then in step 403, the RFID tag 101-1 sends to the RFID reader 102 the status information including the total number NT of RFID tags in the multi-core tag 101 to which the RFID tag 101-1 belongs and the sequence number SN of the RFID tag 101-1 in the multi-core tag 101. If the request received in step 401 is not a request for status information, then in step 404, the RFID tag 101-1 determines whether the request is a request for digital signatures. If the answer is “NO”, then no operation is performed and the process ends. Otherwise, if the answer is “YES”, that is, the RFID tag 101-1 determines that the RFID reader 102 is requesting to read a subset of digital signatures {SIG_{i,a}_{_{—}}₁, SIG_{i,a}_{_{—}}₂, . . . , SIG_{i,a}_{_{—}}ₖ} of the i^{th} set of digital signatures, where 1≦i≦m, 1≦k≦n and {a_{—}1, a_{—}2, . . . , a_k}⊂{1, 2, . . . , n}, i.e., {SIG_{i,a}_{_{—}}₁, SIG_{i,a}_{_{—}}₂, . . . , SIG_{i,a}_{_{—}}ₖ}⊂{SIG_{i,1}, SIG_{i,2}, . . . , SG_{i,n}}, then in step 405, the RFID tag 101-1 sends first to the RFID reader 102 the EPC code stored in the identification code storage area 203. Next, in step 406, the control means 205 determines whether the i^{th} set of digital signatures {SIG_{i,1}, SIG_{i,2}, . . . , SIG_{i,n}} has been locked to another subset of digital signatures {SIG_{i,b}_{_{—}}₁, SIG_{i,b}_{_{—}}₂, . . . , SIG_{i,b}_{_{—}}ₖ} due to being performed a locking operation□ If it has been locked, then the RFID tag 101-1 sends the subset of digital signatures {SIG_{i,b}_{_{—}}₁, SIG_{i,b}_{_{—}}₂, . . . , SIG_{i,b}_{_{—}}ₖ} to the RFID reader 102 in step 407. Then the process ends. If it has not been locked, then in step 408, the control means 205 performs the locking operation to lock the i^{th} set of digital signatures {SIG_{i,1}, SIG_{i,2}, . . . , SIG_{i,n}} in the RFID tag 101-1 to the subset of digital signatures {SIG_{i,a}_{_{—}}₁, SIG_{i,a}_{_{—}}₂, . . . , SIG_{i,a}_{_{—}}ₖ}. As a result, when a reading request as to the i^{th} set of digital signatures {SG_{i,1}, SIG_{i,2}, . . . , SIG_{i,n}} is received in the future, only the subset of digital signatures {SIG_{i,a}_{_{—}}₁, SIG_{i,a}_{_{—}}₂, . . . , SIG_{i,a}_{_{—}}ₖ} can be read, while other digital signatures in the i^{th} set of digital signatures {SIG_{i,1}, SIG_{i,2}, . . . , SIG_{i,n}} can not be read any more. Next, in step 409, the control means 205 determines whether the i^{th} set of digital signatures in RFID tag 101-1 has been locked. If it has not been locked, no operation is performed and the process ends. If it has been locked, the process proceeds to step 410, where the subset of digital signatures {SIG_{i,a}_{_{—}}₁, SIG_{i,a}_{_{—}}₂, . . . , SIG_{i,a}_{_{—}}ₖ} is sent to the RFID reader 102. In this embodiment, the control means 205 performs the locking for example in the following manner: the control means 205 sets a corresponding flag bit Fᵢⱼ with an initial value of 0 for each digital signature SIGᵢⱼ, such that when SIGᵢⱼ is read for the first time, its corresponding flag bit Fᵢⱼ is set to 1, and when the number of digital signatures in the i^{th} set of digital signatures with a flag bit of 1 reaches k, the digital signatures in the i^{th} set of digital signatures with a flag bit not being 1 can not be read any more. The manners for rendering the digital signatures unreadable include for example destroying them, e.g. resetting them to zeroes. The locking can be performed in other ways. For example there are no explicit flag bits in the tag and all the unreadable digital signatures are directly destroyed, e.g. reset to zeroes. Digital signatures all being zeroes may be judged by the tag as digital signatures that do not need to be sent to the reader, or they may be judged by the reader as digital signatures prohibited to be read in case of being sent by the tag. The effects are both causing the digital signatures unreadable to the reader. It is apparent to those skilled in the art that the locking operation can be carried out in other manners in software, hardware or the combination thereof. The present invention is not limited to the specific manners of locking illustrated herein as examples. Those skilled in the art can further appreciate that the “locking” as used herein is merely an exemplary name of the operation for “rendering one or more digital signatures unreadable”, and the invention is not limited to this. Rather, any operation that can “make one or more digital signatures unreadable” can be used with the invention. Note that it is also possible that the RFID tag 101-1 receives a reading request which requests to read another number, e.g. k′, of digital signatures of the i^{th} set of digital signatures, however, no matter k′ equals to k or not, the RFID tag 101-1 will permit at most k digital signatures of the i^{th} set of digital signatures to be read. Furthermore, it is possible that the RFID tag 101-1 receives a reading request for reading the i^{th} set of digital signatures and i>m. In this case, the control means 205 of the RFID tag 101-1 will judge the reading request as an erroneous request and will not respond to it.

FIG. 5 is a flow chart showing the operations of the RFID reader 102 for sending the reading request to the multi-core tag 101 and authenticating the multi-core tag 101 based on the digital signatures received. It should be noted that in the following description, “mutli-core tag authentication” as used herein refers to the process of determining the authenticity of the multi-core tag as a whole; and, depending on the context, the “authentication” mentioned alone can refer to the process of determining the authenticity of an RFID tag in the multi-core tag.

In step 501, the RFID reader 102 chooses an RFID tag in the multi-core tag 101 and sends a status request to it, requesting to read the total number NT and sequence number SN stored in this RFID tag. In step 502, RFID reader 102 obtains the total number NT and sequence number SN sent from the RFID tag. In step 503, RFID reader 102 determines whether this RFID tag has been read during this multi-core tag authentication based on the status information returned. If it has not been read, in step 504, RFID reader 102 sends a request for digital signatures to this RFID tag and makes a judgment based on the data read to obtain the result of authentication for this RFID tag: Fake, Genuine, Error, or All Locked. In step 504, the status of a corresponding variable STATUS_{SN} in an array STATUS recording the read status of each RFID tag in the multi-core tag 101 during this multi-core tag authentication is further set to “READ” by the RFID reader 102 to indicate that the current RFID tag has been read during this multi-core tag authentication, and a variable N_{read} representing the number of RFID tags in the multi-core tag 101 that have been read during this multi-core tag authentication is incremented by 1. Thereafter, in step 505, it is determined whether the result of authenticating the current RFID tag obtained in step 504 is “Error”. If the answer is “YES”, then in step 506, it is concluded that the result of the multi-core tag authentication is “Error”, and this multi-core tag authentication for multi-core tag 101 is ended. Otherwise, in step 507, it is determined whether the result of authenticating the current RFID tag obtained in step 504 is “Fake”. If the answer is “YES”, then in step 508, it is concluded that the result of the multi-core tag authentication is “Fake”, that is, the multi-core tag 101 is a fake one. No more read is necessary, and this multi-core tag authentication for multi-core tag 101 is ended. Otherwise, in step 509, it is determined whether the result of authenticating the current RFID tag obtained in step 504 is “All Locked”. If the answer is “YES”, then in step 510, the conclusion of the multi-core tag authentication for multi-core tag 101 can be drawn as follows: if it can be determined that this is the first time that the multi-core tag 101 is read, then the multi-core tag 101 is a fake one, and no more read is necessary, and the multi-core tag authentication for multi-core tag 101 is ended. If the answer is “NO” in step 509, then in step 511, it is determined whether the result of authenticating the current RFID tag obtained in step 504 is “Genuine”. If the answer is “YES”, then the “Genuine” result is saved and the flow returns to step 501 to continue with selecting another RFID tag in the multi-core tag 101 and sending a status request to it. If the answer is “NO” in step 511, that is, the result of authenticating the current RFID tag is not “Genuine” either, then it can be concluded that an error has occurred in the process. Therefore, in step 513, it is concluded that the result of the multi-core tag authentication for multi-core tag 101 is “Error”. No more read is necessary, and the multi-core tag authentication for multi-core tag 101 is ended.

On the other hand, if the answer is “YES” in step 503, that is, the RFID tag has been read during this multi-core tag authentication, then the process proceeds to step 514, where it is determined whether all RFID tags in the multi-core tag 101 have been read during this mutli-core tag authentication based on the number N_{read} of tags that have been read. If the answer is “YES”, then in step 515, it is determined whether the authentication result of “Genuine” has been obtained for every read according to the “Genuine” results saved. If the answer is “NO”, that is, it is not true that the authentication result for every RFID tag is “Genuine”, then in step 516, it is concluded that the multi-core tag 101 is a fake one. No more read is necessary, and this multi-core tag authentication for multi-core tag 101 is ended. If the answer is “YES” in step 515, that is, the authentication results for all the NT RFID tags in the multi-core tag 101 are all “Genuine”, then it is concluded that this multi-core tag 101 is genuine in step 517. Then this multi-core tag authentication is ended.

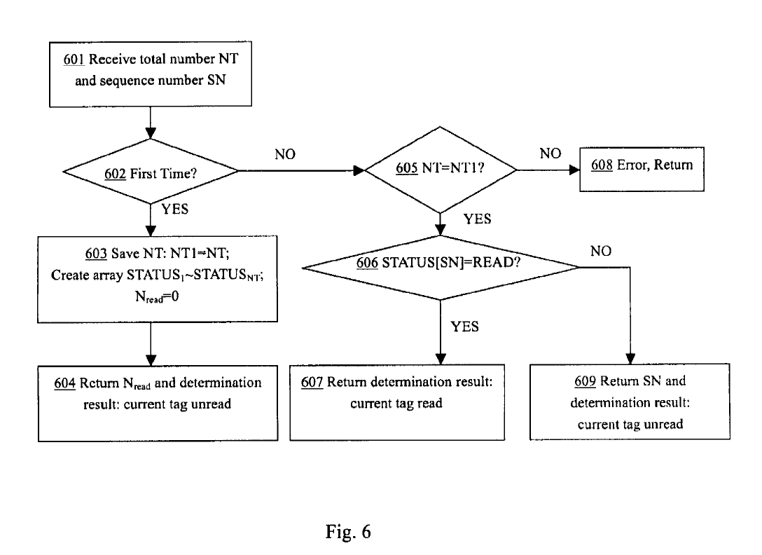

It is explained in further detail below with reference to FIG. 6 the flow of steps 502 and 503 in FIG. 5, i.e., the process that the RFID reader 102 determines whether an RFID tag in the multi-core tag 101 has been read during this multi-core tag authentication based on the status information returned from the RFID tag.

As shown in FIG. 6, in step 601, the RFID reader 102 obtains the status information including the total number NT of tags and sequence number SN sent from an RFID tag in the multi-core tag 101. In step 602, RFID reader 102 determines whether this read is the first read during this multi-core tag authentication. If the answer is “YES”, then in step 603, RFID reader 102 stores the total number NT of tags in an internal memory in it. For example, the total number NT can be saved in a variable NT1 stored in the memory. Additionally, the RFID reader 102 creates a status array with NT elements STATUS₁, STATUS₂, . . . STATUS_{NT}, to store respectively the read status of an RFID tag having a corresponding sequence number during this multi-core tag authentication. Furthermore, the RFID reader 102 resets a counter N_{read} to zero, which represents the number of RFID tags that have been read during this multi-core tag authentication. In step 604, the sub-process shown in FIG. 6 returns the N_{read} and the determination result that the current RFID tag has not been read during this multi-core tag authentication to the process shown in FIG. 5.

On the other hand, if it is determined in step 602 that this read is not the first read during this multi-core tag authentication, then in step 605, it is determined that whether the NT returned equals to the stored NT1. For a genuine multi-core tag, the value NT indicating the total number of tags stored in each RFID tag should be all the same. Therefore, if the answer is “NO” in step 605, it can be seen that there is an error occurred during the read, and the process proceeds to step 608 to return a result of error. And on the other hand, if the answer is “YES” in step 605, then in step 606, it is determined whether the status stored in STATUS_{SN} is “READ”, that is, whether the current RFID tag has been read during this multi-core tag authentication. If the answer is “YES”, then in step 607, the sub-process shown in FIG. 6 returns to the process shown in FIG. 5 the determination result that the current RFID tag has been read during this multi-core tag authentication.

If the answer is “NO” in step 606, then in step 609, the sub-process shown in FIG. 6 returns to the process shown in FIG. 5 the sequence number SN and the determination result that the current RFID tag has not been read during this multi-core tag authentication.

It should be noted that the process shown in FIG. 6 is merely exemplary. Those skilled in the art can recognize that other methods can also be employed to determine whether an RFID tag in the multi-core tag has been read by the RFID reader 102 during a multi-core tag authentication, and other information can also be included in the status information returned from the RFID tags. The invention is not limited to the specific embodiments given herein.

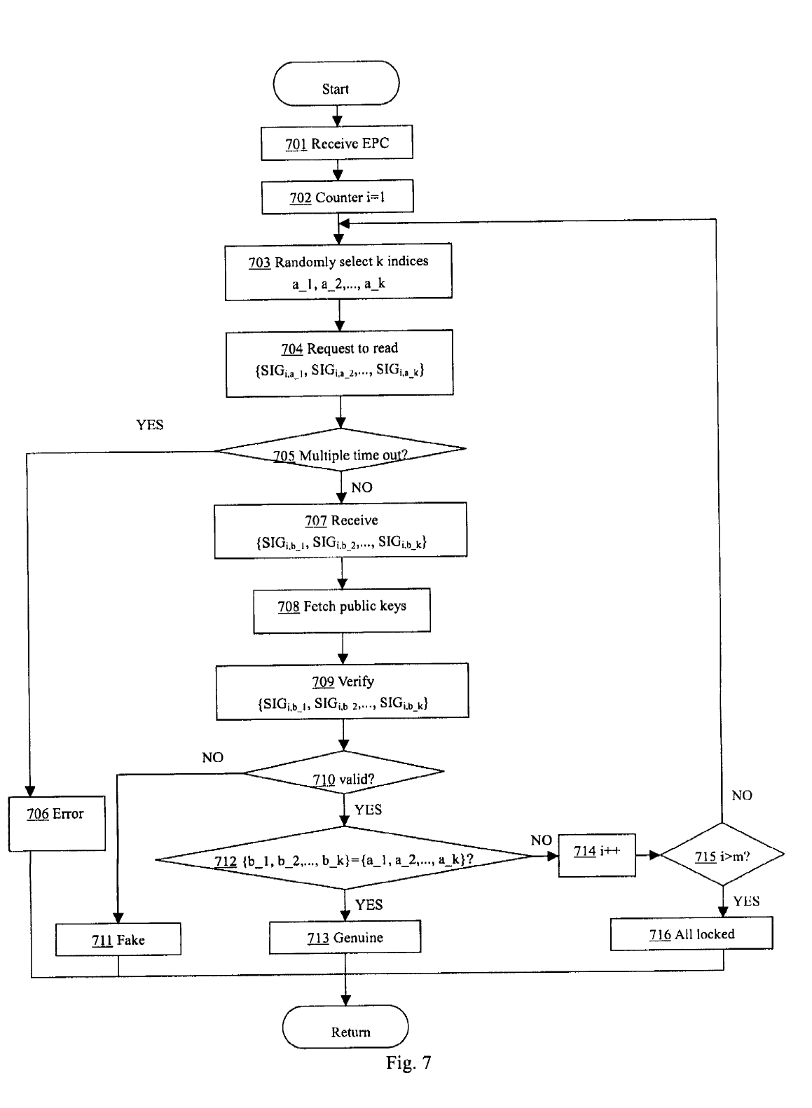

The flow of the step 504 in FIG. 5 will be explained below in further detail with reference to FIG. 7. Here, the RFID tag 101-1 is again taken as an example to explain the flow. The flow of operations of other RFID tags in the multi-core tag 101 is similar to that of RFID tag 101-1. First, in step 701, the RFID reader 102 receives the identification code, i.e., the EPC code, sent from the RFID tag 101-1, so that an attribute uniquely identifying the RFID tag 101-1 is determined, and therefore it is determined which public key or which set of public keys stored in the memory should be used to verify the read digital signatures. Then, in step 702, the value i of a counter (not shown) in the processor 301 of the RFID reader 102 is set to 1. Then in step 703, the processor 301 randomly selects a subset of indices {a_{—}1, a_{—}2, . . . , a_k} from the set of indices {1, 2, . . . , n}. Next, in step 704, the processor 301 controls the RFID reader 102 to send a reading request to the RFID tag 101-1 through the reader coupling element 303, requesting to read a subset of digital signatures {SIG_{i,a}_{_{—}}₁, SIG_{i,a}_{_{—}}₂, . . . , SIG_{i,a}_{_{—}}ₖ} of the i^{th} set of digital signatures, and starts to wait for the reply data from the RFID tag 101-1. In step 705, the processor 301 determines whether it has been timed out for multiple times. If the answer is “YES”, then in step 706 the authentication section 301-1 determines that there has been an error, that is, the result of authentication is “Error”. Here, the times of time out before determining there is an error can be selected as needed. The manners of selecting are well known to those skilled in the art. If, in step 705, a subset of digital signatures {SIG_{i,b}_{_{—}}₁, SIG_{i,b}_{_{—}}₂, . . . , SIG_{i,b}_{_{—}}ₖ} sent from the RFID tag 101-1 was received before multiple times of time out (step 707), then in step 708, the processor 301 fetches the public keys corresponding to the manufacturer from the memory 304. Next, in step 709, the subset of digital signatures {SIG_{i,b}_{_{—}}₁, SIG_{i,b}_{_{—}}₂, . . . , SIG_{i,b}_{_{—}}ₖ} is verified by using the public keys of the manufacturer. In step 710, the validity of the subset of digital signatures {SIG_{i,b}_{_{—}}₁, SIG_{i,b}_{_{—}}₂, . . . , SIG_{i,b}_{_{—}}ₖ} is judged. If it's invalid, then the authentication section 301-1 determines that the RFID tag 101-1 is a fake tag, thus the product being attached the multi-core tag 101 containing the RFID tag 101-1 is a fake product, that is, the result of authentication is “Fake” (step 711). If it's valid, then in step 712, it is determined whether the subset of indices {b_{—}1, b_{—}2, . . . , b_k} equals to the subset of indices {a_{—}1, a_{—}2, . . . , a_k} randomly selected in step 703. If the answer is “YES”, then the authentication section 301-1 judges that the RFID tag 101-1 is a genuine tag, that is, the result of this authentication is “Genuine” (step 713). Otherwise, the processor 301 increments the value i of the counter by 1 in step 714, and determines whether i>m in step 715. If i>m, then the authentication section 301-1 determines that every set of digital signatures in the RFID tag 101-1 has been read before and locked, that is, the result of this authentication is “All Locked” (step 716). Otherwise the process returns to step 703, and step 703 and subsequent flow are repeated. Through the above process, the RFID reader 102 can authenticate the RFID tag 101-1.

It can be seen from the above description that, the outcome of performing the “locking” operation in the tag is that tag cloning is prohibited. First, take m=1, k=1 and NT=1 as an example for computing the probability of detecting fake products. That is, there is only one RFID tag in each multi-core tag, the RFID tag contains only one set of digital signatures, and each time the RFID reader will request to read one signature in the set of digital signatures. A forger can only obtain one of all n digital signatures stored in the RFID tag in a genuine mutli-core tag. Other n−1 digital signatures will never be read. Therefore, a fake tag will only contain one valid digital signature. Hence cloned tag is no more seen. When such a fake tag is authenticated by a genuine reader, since the reader will randomly select i from {1, 2, . . . n}, and request to read SIGᵢ in the RFID tag contained in the multi-core tag, a fake multi-core tag will be detectable at probability (n−1)/n. In general, p fake multi-core tags are detectable at probability 1−(1/n)^{p}. Taking n=2 as example, one fake multi-core tag can escape detection at a probability of 50%, while a dozen fake multi-core tags can only escape detection at a probability lower than 0.025%. Or in other words, a dozen fake multi-core tags are detectable at a probability higher than 99.97%. Obviously, if 1<k<n*0.5, then the probability that the fake multi-core tags will be detected will be even higher. When k=n*0.5, the probability of detection is highest. For example, n=12, i.e., there is a set constituted by 12 digital signatures stored in an RFID tag contained in a multi-core tag, and k=6, i.e. 6 digital signatures are randomly selected for authentication from the 12 digital signatures. Since there are at most 6 digital signatures in a fake multi-core tag, the fake multi-core tag will be detectable at a probability of 1−1/C₁₂⁶, i.e., 99.89%. At this time, two fake multi-core tags can escape detection at a probability lower than 0.00012%. It's now rational to conclude that the solution of authenticating products by using an RFID system including a multi-core tag containing RFID tags with locking function as provided by the invention can effectively and efficiently thwarts mass counterfeits.

Furthermore, in case that there are multiple RFID tags in a multi-core tag, the probability that a fake multi-core tag will be detected is further increased. It is assumed herein again that m=1 and k=1, but NT>1. That is, there are more than one RFID tags in the multi-core tag, each RFID tag contains one set of digital signatures including n digital signatures, and each time the RFID reader will request to read one of the n digital signatures. As described above, only when the results of authenticating the RFID tags in the multi-core tag are all “Genuine” as determined by the RFID reader, can the multi-core tag be authenticated as genuine by the RFID reader. It is not hard to infer that the probability that the results of authenticating the NT RFID tags in a fake multi-core tag are all “Genuine” is (1/n)^{NT}. Therefore, a fake multi-core tag will be detectable at probability 1−(1/n)^{NT}. Taking n=2 as example again, if NT=12, that is, there are 12 RFID tags in a multi-core tag, then a fake multi-core tag will be detectable at a probability of 99.97%.

In addition, the advantage of adopting multiple sets of digital signatures is obvious. With m sets, it can be guaranteed that a real RFID tag will be authenticated as authentic by the reader for at least m times. This is useful because sometimes a product is bought as gift and may pass by several persons before it is consumed. In this scenario, not only the buyer or the final consumer, but also the intermediate persons may intend to authenticate the product. When m sets are stored on each RFID tag, each RFID tag will be verified as authentic for at least m times. And accordingly, the number of times that a multi-core tag containing such RFID tags can be authenticated as authentic is also increased.

The exemplary implementations of the invention have been provided above. In other embodiments, other modifications and variations can be made without departing from the scope of the invention. For example, in the above embodiments, it is not specified which set of digital signatures should be read when reading each RFID tag during a multi-core tag authentication. That is, when an RFID tag is read, the first set of digital signatures therein will be read first and whether the set has been locked will be determined depending on whether the indices of the digital signatures that have been read are identical to the indices of the digital signatures that are requested to be read. If the set has been locked, the next set of digital signatures in this RFID tag will be read. However, the invention is not limited to this. In another embodiment, a variable, for example S_{unread}, can be set for each REID tag in the mutli-core tag, to indicate the sequence number of the set of digital signatures with a minimum sequence number among the sets of digital signature in the RFID tag that have not been locked at present. The value of S_{unread} can be sent to the RFID reader before each time before the digital signatures are read, for example, together with the EPC code, and can be incremented each time after the RFID tag is read. In this way, the RFID reader can directly begin with reading this set of digital signatures when reading the RFID tag. For example, if none of the sets of digital signatures in the RFID tag has been locked, then S_{unread}=1, and the RFID reader will begin with reading the first set of digital signatures in this RFID tag. After the first set of digital signatures is locked and read, S_{unread} is incremented to 2. Thus next time when the RFID reader is to read the RFID tag, it can start with the second set of digital signatures directly, and does not need to determine whether the first set of digital signatures has been locked based on the result of reading the first set of digital signatures. When the RFID reader learns that S_{unread}>m, it can infer that all sets of digital signatures in the RFID tag have been locked, and then the RFID reader can directly come to the conclusion “All Locked”.

As another alternative, a flag “Locked” can be set for each set of digital signatures in each RFID tag in the multi-core tag. When a set of digital signatures is requested to be read for the first time, the RFID tag performs a locking operation on this set of digital signatures and sets the flag “Locked” to, for example 1, to indicate that this set of digital signatures has been locked. In this way, when the next time the RFID reader requests to read this set of digital signatures, the RFID tag can directly returns the flag “Locked” to the RFID reader to indicate that the corresponding set of digital signatures has been locked. Thus, unlike the above embodiments shown in FIGS. 4 and 7, the RFID reader does not need to determine whether a set of digital signatures has been locked based on whether the indices of the digital signatures that have been returned are identical to the indices of the digital signatures that are requested to be read.

In the above embodiments, the verifiable data are digital signatures. However, it is apparent to those skilled in the art that, for other forms of verifiable data, the technical effects of having the genuine tags pass the authentication while preventing them from being cloned can also be achieved through the “locking” function as proposed by the invention. And the technical solutions of the invention can be readily implemented using various forms of verifiable data by those skilled in the art upon reading the description.

It can be seen from the above that, according to the embodiments of the invention, a “locking” function is introduced into an RFID tag. And furthermore, multiple RFID tags are aggregated into a multi-core tag. As such, the probability that a fake product will be detected can be significantly increased through a plurality of digital signatures stored in each RFID tag and the locking function carried out by each RFID tag as well as the authentication performed as a whole on all the RFID tags in the multi-core tag. Thus cloning of data in an inexpensive radio frequency identification tag can be effectively prevented and mass counterfeits can be thwarted.

In addition, in each RFID tag, multiple digital signatures are divided into sets and stored in the RFID tag. By introducing signature sets, it's guaranteed that a genuine tag could be verified as authentic for at least m times, where m is the number of sets of digital signatures.

Although the invention has been described with reference to the particular preferred embodiments, it is to be understood by those skilled in the art that various modifications as to forms and details can be made therewith out departing from the spirit and scope of the invention as defined by the appended claims.

1. A radio frequency identification system, comprising:
a multi-core tag including a plurality of radio frequency identification tags, each radio frequency identification tag having an identification code and at least one set of verifiable data stored therein; and
a radio frequency identification reader which sends a reading request to more than one radio frequency identification tag in the multi-core tag, requesting to read a first portion of one of the at least one set of verifiable data stored in the radio frequency identification tag, and authenticates the multi-core tag based on the data read from the multi-core tag, wherein
each radio frequency identification tag in the multi-core tag further comprises control means, which, when the radio frequency identification tag receives the reading request from the radio frequency identification reader, in the event that all the data of the requested set of verifiable data is readable, performs a first operation so that from then on at least one data of the requested set of verifiable data cannot be read.

2. The radio frequency identification system according to claim 1, wherein each radio frequency identification tag in the multi-core tag, when receiving a status request from the radio frequency identification reader, provides the radio frequency identification reader with information regarding the number of the radio frequency identification tags in the multi-core tag and a sequence number of the radio frequency identification tag in the multi-core tag.

3. The radio frequency identification system according to claim 1, wherein each radio frequency identification tag in the multi-core tag has the first portion of the requested set of verifiable data be read by the radio frequency identification reader after performing the first operation.

4. The radio frequency identification system according to claim 1, wherein each radio frequency identification tag in the multi-core tag, in the event that the requested set of verifiable data has been performed the first operation, provides the radio frequency identification reader with a portion of data in the set of verifiable data that is still readable.

5. The radio frequency identification system according to claim 1, wherein each radio frequency identification tag in the multi-core tag, in the event that the requested set of verifiable data has been performed the first operation, provides the radio frequency identification reader with information indicating a portion of the set of verifiable data cannot be read.

6. The radio frequency identification system according to claim 1, wherein the multi-core tag is attached onto a product to be authenticated, and the identification code includes an Electronic Product Code.

7. The radio frequency identification system according to claim 1, wherein the data in the at least one set of verifiable data stored in each radio frequency identification tag of the multi-core tag is obtained by encrypting the identification code stored in the radio frequency identification tag.

8. The radio frequency identification system according to claim 1, wherein the data in the at least one set of verifiable data stored in each radio frequency identification tag of the multi-core tag is obtained by encrypting the identification code and other information stored in the radio frequency identification tag.

9. The radio frequency identification system according to claim 1, wherein the at least one data of the requested set of verifiable data does not include any data in the first portion of the requested set of verifiable data.

10. The radio frequency identification system according to claim 1, wherein each of the at least one set of verifiable data stored in each radio frequency identification tag in the multi-core tag includes n digital signatures SIG₁, SIG₂ . . . SIGₙ, and the first portion includes k digital signatures of the n digital signatures.

11. The radio frequency identification system according to claim 10, wherein k=n*0.5 if n is even; and k=n*0.5+0.5 or k=n*0.5−0.5 if n is odd.

12. A multi-core tag comprising a plurality of radio frequency identification tags, each radio frequency identification tag having an identification code and at least one set of verifiable data stored therein, wherein
each radio frequency identification tag in the multi-core tag comprises control means, which, when the radio frequency identification tag receives a reading request for reading a first portion of one of the at least one set of verifiable data stored in the radio frequency identification tag, in the event that all the data of the requested set of verifiable data is readable, performs a first operation so that from then on at least one data of the requested set of verifiable data cannot be read.

13. The multi-core tag according to claim 12, wherein each radio frequency identification tag in the multi-core tag, when receiving a status request, provides information regarding the number of the radio frequency identification tags in the multi-core tag and a sequence number of the radio frequency identification tag in the multi-core tag.

14. The multi-core tag according to claim 12, wherein each radio frequency identification tag in the multi-core tag has the first portion of the requested set of verifiable data be read after performing the first operation.

15. The multi-core tag according to claim 12, wherein each radio frequency identification tag in the multi-core tag, in the event that the requested set of verifiable data has been performed the first operation, provides a portion of data in the set of verifiable data that is still readable.

16. The multi-core tag according to claim 12, wherein each radio frequency identification tag in the multi-core tag, in the event that the requested set of verifiable data has been performed the first operation, provides information indicating a portion of the set of verifiable data cannot be read.

17. The multi-core tag according to claim 12, wherein the multi-core tag is attached onto a product to be authenticated, and the identification code includes an Electronic Product Code.

18. The multi-core tag according to claim 12, wherein the data in the at least one set of verifiable data stored in each radio frequency identification tag of the multi-core tag is obtained by encrypting the identification code stored in the radio frequency identification tag.

19. The multi-core tag according to claim 12, wherein the data in the at least one set of verifiable data stored in each radio frequency identification tag of the multi-core tag is obtained by encrypting the identification code and other information stored in the radio frequency identification tag.

20. The multi-core tag according to claim 12, wherein the at least one data of the requested set of verifiable data does not include any data in the first portion of the requested set of verifiable data.

21. The multi-core tag according to claim 12, wherein each of the at least one set of verifiable data stored in each radio frequency identification tag in the multi-core tag includes n digital signatures SIG₁, SIG₂ . . . , SIGₙ, and the first portion includes k digital signatures of the n digital signatures.

22. The multi-core tag according to claim 21, wherein k=n*0.5 if n is even; and k=n*0.5+0.5 or k=n*0.5−0.5 if n is odd.

23. A radio frequency identification method, comprising:
storing an identification code and at least one set of verifiable data in each of a plurality of radio frequency identification tags included in a multi-core tag; and
sending a reading request from a radio frequency identification reader to more than one radio frequency identification tag in the multi-core tag to request to read a first portion of one of the at least one set of verifiable data stored in the radio frequency identification tag, and authenticating the multi-core tag based on the data read from the multi-core tag, wherein
each radio frequency identification tag in the multi-core tag, when receiving the reading request from the radio frequency identification reader, in the event that all the data of the requested set of verifiable data is readable, performs a first operation so that from then on at least one data of the requested set of verifiable data cannot be read.

24. The radio frequency identification method according to claim 23, further comprising when each radio frequency identification tag in the multi-core tag receives a status request from the radio frequency identification reader, providing information regarding the number of the radio frequency identification tags in the multi-core tag and a sequence number of the radio frequency identification tag in the multi-core tag to the radio frequency identification reader from the radio frequency identification tag.

25. The radio frequency identification method according to claim 23, further comprising having the first portion of the requested set of verifiable data be read after performing the first operation.

26. The radio frequency identification method according to claim 23, further comprising in the event that the requested set of verifiable data has been performed the first operation, providing the radio frequency identification reader with a portion of data in the set of verifiable data that is still readable.

27. The radio frequency identification method according to claim 23, further comprising in the event that the requested set of verifiable data has been performed the first operation, providing the radio frequency identification reader with information indicating a portion of the set of verifiable data cannot be read.

28. The radio frequency identification method according to claim 23, further comprising attaching the multi-core tag onto a product to be authenticated, and wherein the identification code includes an Electronic Product Code.

29. The radio frequency identification method according to claim 23, further comprising obtaining the data in the at least one set of verifiable data stored in each radio frequency identification tag of the multi-core tag by encrypting the identification code stored in the radio frequency identification tag.

30. The radio frequency identification method according to claim 23, further comprising obtaining the data in the at least one set of verifiable data stored in each radio frequency identification tag of the multi-core tag by encrypting the identification code and other information stored in the radio frequency identification tag.

31. The radio frequency identification method according to claim 23, wherein the at least one data of the requested set of verifiable data does not include any data in the first portion of the requested set of verifiable data.

32. The radio frequency identification method according to claim 23, wherein each of the at least one set of verifiable data stored in each radio frequency identification tag in the multi-core tag includes n digital signatures SIG₁, SIG₂ . . . , SIGₙ, and the first portion includes k digital signatures of the n digital signatures.

33. The radio frequency identification method according to claim 32, wherein k=n*0.5 if n is even; and k=n*0.5+0.5 or k=n*0.5−0.5 if n is odd.
